(19) United States
(12) Patent Application Publication
(10) Pub. No.: US 2011/0302143 A1
(43) Pub. Date: Dec. 8, 2011

(54) MULTI-VERSION CONCURRENCY WITH ORDERED TIMESTAMPS

(75) Inventor: David B. Lomet, Redmond, WA (US)

(73) Assignee: Microsoft Corporation, Redmond, WA (US)

(21) Appl. No.: 12/791,898

(22) Filed: Jun. 2, 2010

(51) Int. Cl. G06F 17/30

(52) U.S. Cl. 707/704; 707/E17.007; 707/687

(57) ABSTRACT

Multiple versions of a set of data objects can be maintained to allow concurrent conflicting access to the objects. Additionally, a range of acceptable timestamps for each transaction in a set of database transactions can be tracked. Conflicting access requests for an object in the set of objects can be detected, and the requests can be made by two or more conflicting transactions in the set of transactions. A range of acceptable timestamps for at least one of the conflicting transactions can be adjusted, such that an order of transaction timestamps can be maintained in accordance with a specified transaction isolation level. Such timestamp range adjustment can frequently permit conflicting read and write accesses to proceed concurrently. When concurrent access cannot be allowed while maintaining such an order of transaction timestamps, in many cases one of the conflicting accesses can be blocked instead of aborting one of the transactions.

### BACKGROUND

Today, database management systems often use locking to provide appropriate transaction isolation levels, such as serializable, repeatable read, read uncommitted, read committed, snapshot isolation, etc. Serializable transactions are ones that, when executed concurrently, produce an effect as if they were ordered in some sequence such that the transactions executed one by one in sequence order. That is, the effect for concurrent execution is the same as if the transactions were executed singly in some order. Locking for serializability in many cases is fine, but in the case where there is a transaction that reads a large amount of data, and perhaps executes for an extended period, locking can result in greatly reduced concurrency and unsatisfactory throughput. Database management systems can allow transaction isolation levels based on conflicts that are less stringent than the serializable isolation level (repeatable read, read committed, read uncommitted, snapshot isolation, etc.). Such less stringent isolation levels may allow some increased concurrency as compared to the serializable transaction isolation level, but in many cases these less stringent isolation levels do not produce advantages that may be present with serializable transactions. Isolation levels may be specified in different ways, such as by using a system that only allows a single isolation level, by explicitly specifying an isolation level, and/or by having a default isolation level that can be specified implicitly by not explicitly specifying another level.

### SUMMARY

Whatever the advantages of previous database management tools and techniques, they have neither recognized the tools and techniques described and claimed herein, nor the advantages produced by such tools and techniques.

In one embodiment, the tools and techniques can include maintaining multiple versions of a set of data objects to allow concurrent conflicting access to the data objects. Additionally, a range of acceptable timestamps for each database transaction in a set of database transactions can be tracked. Conflicting access requests for a data object in the set of data objects can be detected, where the requests are made by two or more conflicting database transactions in the set of transactions. A range of acceptable timestamps for at least one of the conflicting transactions can be adjusted, such that an order of transaction timestamps can be maintained in accordance with a specified transaction isolation level. For example, the isolation level may be a serializable isolation level, so that a serializable order of transaction timestamps for the set of database transactions can be maintained.

As used herein, an order of transaction timestamps being maintained in accordance with a specified isolation level refers to timestamps for transactions (such as a specific timestamp and/or range of timestamps for each transaction) being in an order that is consistent with an ordering of the transactions in accordance with the specified isolation level. For example, a serializable order of transaction timestamps and similar terms refer to timestamps for transactions being in a serializable sequence order for the transactions. Concurrent, concurrently and similar terms refer to occurrences during real clock time ranges that overlap, at least to some extent. As used herein, conflicting, conflict, and similar terms refer to accesses, operations, transactions, etc. that are determined to conflict with each other under specified rules or policies, such as under rules of a conflict manager that is detecting such conflicts. For example, conflicts may be determined using standard lock manager principles (S lock requests and corresponding accesses and operations conflict with overlapping X lock requests and corresponding accesses and operations, X lock requests and corresponding accesses and operations conflict with other X lock requests and corresponding accesses and operations that overlap, S lock requests and corresponding accesses and operations do not conflict with other S lock requests and corresponding accesses and operations even if they overlap, etc.).

In another embodiment of the tools and techniques, a request can be received for a first transaction to access a data object in a set of data objects to perform a write operation on the data object to produce a modified version of the object. A request can also be received for a second transaction to access the data object to perform a read operation on the data object. The first transaction can be allowed to access the data object to perform the write operation, while the second transaction can be concurrently allowed to access an earlier version of the data object to perform the read operation, where the earlier version is prior to the modified version. A range of acceptable timestamps for at least one of the first and second transactions can be adjusted, such that an acceptable timestamp range for the first transaction and an acceptable timestamp range for the second transaction are in an order of transaction timestamps that is in accordance with a specified transaction isolation level.

In yet another embodiment of the tools and techniques, a request can be received for a first transaction to access a data object to perform a first operation on the data object, and another request can be received for a second transaction to access the data object to perform a second operation on the data object, where the first and second operations conflict. It can be determined whether one or both of the acceptable timestamp ranges for the first and second transactions can be adjusted to allow the first and second operations to proceed concurrently while maintaining an order of transaction timestamps in accordance with a specified transaction isolation level. If so, then the first and second operations can be allowed to proceed concurrently, and one or both of the acceptable timestamp ranges for the first and second transactions may be adjusted to maintain an order of transaction timestamps in accordance with the specified transaction isolation level. If not, then it can be determined whether one or both of the acceptable timestamp ranges for the first and second transactions can be adjusted to allow either the first or the second transaction to be blocked while the other can proceed, and one or both of the acceptable timestamp ranges of the first and second transactions may be adjusted to maintain an order of transaction timestamps in accordance with the specified transaction isolation level.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described embodiments may be implemented.

FIG. 2 is a schematic diagram of a database environment.

FIG. 3 is a flowchart of a technique for multi-version concurrency with ordered timestamps.

FIG. 4 is a flowchart of another technique for multi-version concurrency with ordered timestamps.

FIG. 5 is a flowchart of yet another technique for multi-version concurrency with ordered timestamps.

### DETAILED DESCRIPTION

Embodiments described herein are directed to techniques and tools for improved management of database transactions for ordering in accordance with specified isolation levels using timestamps. Such improvements may result from the use of various techniques and tools separately or in combination.

Such techniques and tools may include maintaining multiple versions of a set of data objects (i.e., at least one of the data objects having multiple versions maintained) to allow concurrent conflicting access to the data objects. A range of acceptable time stamps can be tracked for each database transaction in a set of database transactions. Conflicting access requests for the same data object may be detected. For example, a read access request (e.g., a request for an S lock) and a write access request (e.g., a request for an X lock) for the same object may be made for overlapping time periods, such as where a request is made by one transaction when another is already accessing the data object. A range of acceptable timestamps for at least one of the conflicting transactions that made the requests may be adjusted, such that a timestamp within the range can be chosen to maintain an order of transaction timestamps for the set of database transactions in accordance with a specified transaction isolation level.

As an example, a writing transaction may be allowed to proceed with accessing the most recent version of an object to write to the object and produce a new modified version of the object. A reading transaction may be allowed to concurrently proceed with accessing a version of the object that is earlier than the new modified version of the object. One or both of the timestamp ranges for the transactions can be adjusted so that a range of acceptable timestamps for the reading transaction comes before a range of acceptable timestamps for the writing transaction. Accordingly, the range of acceptable timestamps for the writing transaction may be adjusted so that it will come after the range of acceptable timestamps for the reading transaction and/or the range of acceptable timestamps for the reading transaction may be adjusted so that it will come before the range for the writing transaction. If it is determined that timestamp ranges cannot be adjusted in this manner, then one or both of the transactions may be blocked (if blocking can be done so that the range of acceptable timestamps can be adjusted to maintain the order of transaction timestamps in accordance with a specified isolation level) or aborted.

As another example, a first writing transaction may be allowed to proceed with accessing the most recent version of an object to write to the object and to produce a new modified version of the object, while a second writing transaction is blocked from accessing the object. After the first writing transaction ceases accessing the object, the second writing transaction can access the new modified version of the object to produce another newer modified version of the object. One or both of the timestamp ranges for the two transactions may be adjusted so that a range of acceptable timestamps for the first writing transaction comes before a range of acceptable timestamps for the second writing transaction. If it is determined that timestamp ranges cannot be adjusted in this manner, then one or both of the transactions may be aborted.

When a transaction ends, it can be assigned a timestamp from its range of acceptable timestamps. This range of acceptable timestamps may be within a range between the actual clock time for the start of the transaction and the actual clock time for the end of the transaction.

One or more substantial benefits can be realized from the tools and techniques described herein. For example, concurrent read/write access can be allowed by using multiple versions of data objects. This can be done while maintaining timestamps for the transactions in an order in accordance with a specified isolation level. For example, the order may be a serializable order of timestamps. This can allow transaction time database functionality to be supported (e.g., queries may be answered in a transactionally consistent way “as of” a specified time in the past). Additionally, writers may be aborted less often when writer-writer conflicts occur by blocking a writer instead of aborting it in many such situations (so long as the acceptable timestamp ranges can be adjusted to maintain the order of transaction timestamps in accordance with the specified isolation level).

The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Techniques described herein with reference to flowcharts may be used with one or more of the systems described herein and/or with one or more other systems. For example, the various procedures described herein may be implemented with hardware or software, or a combination of both. Moreover, for the sake of simplicity, flowcharts may not show the various ways in which particular techniques can be used in conjunction with other techniques.

### I. Exemplary Computing Environment

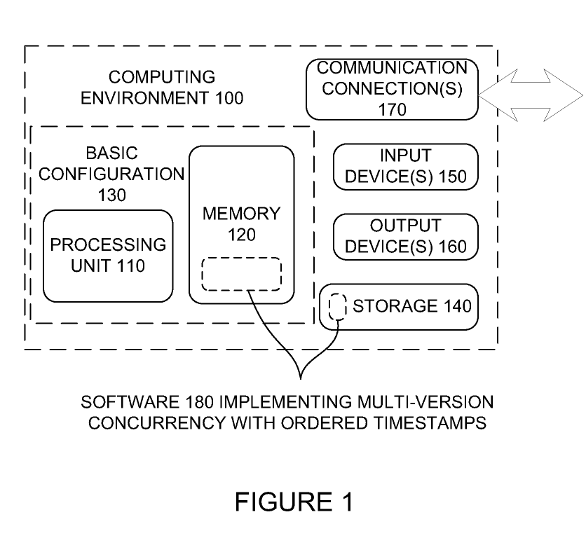

FIG. 1 illustrates a generalized example of a suitable computing environment (100) in which one or more of the described embodiments may be implemented. For example, one or more such computing environments can be used as a database environment. Generally, various different general purpose or special purpose computing system configurations can be used. Examples of well-known computing system configurations that may be suitable for use with the tools and techniques described herein include, but are not limited to, server farms and server clusters, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The computing environment (100) is not intended to suggest any limitation as to scope of use or functionality of the invention, as the present invention may be implemented in diverse general-purpose or special-purpose computing environments.

With reference to FIG. 1, the computing environment (100) includes at least one processing unit (110) and memory (120). In FIG. 1, this most basic configuration (130) is included within a dashed line. The processing unit (110) executes computer-executable instructions and may be a real or a virtual processor. In a multi-processing system, multiple processing units execute computer-executable instructions to increase processing power. The memory (120) may be volatile memory (e.g., registers, cache, RAM), non-volatile memory (e.g., ROM, EEPROM, flash memory), or some combination of the two. The memory (120) stores software (180) implementing multi-version concurrency with ordered timestamps.

Although the various blocks of FIG. 1 are shown with lines for the sake of clarity, in reality, delineating various components is not so clear and, metaphorically, the lines of FIG. 1 and the other figures discussed below would more accurately be grey and blurred. For example, one may consider a presentation component such as a display device to be an I/O component. Also, processors have memory. The inventors hereof recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computer,” “computing environment,” or “computing device.”

A computing environment (100) may have additional features. In FIG. 1, the computing environment (100) includes storage (140), one or more input devices (150), one or more output devices (160), and one or more communication connections (170). An interconnection mechanism (not shown) such as a bus, controller, or network interconnects the components of the computing environment (100). Typically, operating system software (not shown) provides an operating environment for other software executing in the computing environment (100), and coordinates activities of the components of the computing environment (100).

The storage (140) may be removable or non-removable, and may include non-transitory computer-readable storage media such as magnetic disks, magnetic tapes or cassettes, CD-ROMs, CD-RWs, DVDs, or any other medium which can be used to store information and which can be accessed within the computing environment (100). The storage (140) stores instructions for the software (180).

The input device(s) (150) may be a touch input device such as a keyboard, mouse, pen, or trackball; a voice input device; a scanning device; a network adapter; a CD/DVD reader; or another device that provides input to the computing environment (100). The output device(s) (160) may be a display, printer, speaker, CD/DVD-writer, network adapter, or another device that provides output from the computing environment (100).

The communication connection(s) (170) enable communication over a communication medium to another computing entity. Thus, the computing environment (100) may operate in a networked environment using logical connections to one or more remote computing devices, such as a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable media. Computer-readable media are any acceptable media that can be accessed within a computing environment. By way of example, and not limitation, with the computing environment (100), computer-readable media include memory (120), storage (140), and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment. In a distributed computing environment, program modules may be located in both local and remote computer storage media.

For the sake of presentation, the detailed description uses terms like “determine,” “choose,” “adjust,” and “operate” to describe computer operations in a computing environment. These and other similar terms are high-level abstractions for operations performed by a computer, and should not be confused with acts performed by a human being, unless performance of an act by a human being (such as a “user”) is explicitly noted. The actual computer operations corresponding to these terms vary depending on the implementation.

### II. Database System and Environment

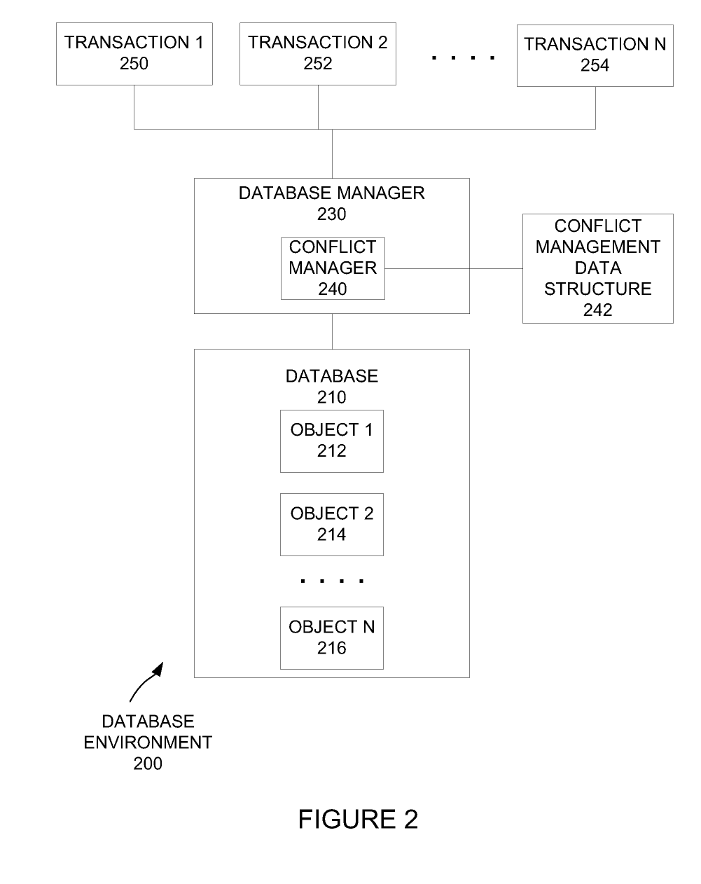

FIG. 2 is a block diagram of a database environment (200) in conjunction with which one or more of the described embodiments may be implemented. The database environment (200) can include a database (210) having a series of data objects (212, 214, 216), such as database records, columns, tables, etc. A database manager (230) can be part of a database server, such as a database server running Microsoft SQL Server® database server application software. The database manager (230) can manage the database (210), and can include a conflict manager (240), which can access a conflict management data structure (242) (which may actually include multiple structures). The conflict manager (240) can manage conflicts between transactions (250, 252, and 254) that request access to the data objects (212, 214, and 216). In so doing, the conflict manager (240) can maintain ranges of acceptable timestamps for active transactions (250, 252, and 254) in the conflict management data structure (242), and can adjust those ranges to maintain an order of transaction timestamps in accordance with a specified isolation level, such as a serializable order of transaction timestamps that is consistent with the data versions being accessed. In the discussion that follows, the example of a specified serializable isolation level will be discussed, and then other isolation levels will be discussed in the section entitled Isolation Levels. The conflict manager (240) can also save assigned timestamps for completed transactions (250, 252, and/or 254) in the conflict management data structure (242) or some other data structure. The operation of the conflict manager (240) and the conflict management data structure (242) will be discussed in more detail in the following sections.

### III. Conflict Manager and Conflict Management Data Structure

The conflict manager (240) can use multi-version concurrency control to utilize extra versions of data objects to enable concurrent read/write access to a data object (212, 214, or 216). Simultaneous read and write of a single data object (212, 214, or 216) is typically considered a conflicting access, except when dirty read isolation is used. However, concurrent access to the data object (212, 214, or 216) can be achieved by permitting the reader (i.e., a transaction (250, 252, or 254) requesting read access to the data object (212, 214, or 216)) to read a version earlier than the one that the writing transaction (i.e., a transaction (250, 252, or 254) requesting write access to the data object (212, 214, or 216)) is providing.

The conflict manager (240) can use a substantially conventional lock manager to detect conflicting accesses. Instead of working from special lock modes, the conflict manager can use the nature of the current access request to decide whether it is characterized as a read or a write access request, and can respond appropriately. Whether a conflict is present can be determined using conventional rules for lock managers and the conventional lock modes. For example, two writers requesting access to a data object during the same time period will have lock modes that conflict with each other, and similarly, a reader and a writer requesting access to a data object during the same time period will conflict with each other, but two readers requesting access to a data object during the same time period will not conflict with each other.

The conflict manager (240) can use conflicting accesses to adjust the range of timestamps that can be assigned to a transaction for versions that the transaction produces so that the correct version for any given access can be determined. Accordingly, an appropriate timestamp for a transaction can be chosen, and transaction conflicts can be used to guide this choice by setting boundaries on what a transaction's timestamp can be in order for timestamp order and serialization order to agree (i.e., for the order of transaction timestamps to be serializable). When no acceptable timestamp range can be found for a transaction while keeping the transaction timestamp order serializable, the transaction may be aborted.

By adjusting acceptable timestamp ranges for the transactions, the conflict manager (240) can tag each transaction (250, 252, and 254) with a timestamp within the range so that the transaction timestamps are in an order consistent with the transaction isolation level, e.g., serialization (i.e., serializable) order. This can allow support for transaction time database functionality. Each assigned transaction timestamp can be at or between the actual transaction start clock time and the actual transaction end clock time (i.e., actual transaction commit clock time) for the transaction (250, 252, or 254). This can facilitate natural temporal queries. Additionally, the database manager (230) can be configured to reduce the incidence of aborts. The incidence of such aborts is a downside to some prior techniques, such as typical snapshot isolation techniques, which aborts in all write/write conflict cases. In some prior techniques allowing concurrency, some read/write conflicts have also resulted in aborts.

In addition, conflict manager (240) as described in the implementation below may enable one or more of the following capabilities: blocking in many cases on write-write and read-write conflicts that would abort using other techniques; a “one pass” strategy in which ranges can be adjusted at the moment a conflict is discovered, so that the timestamp range of a transaction can reflect all transaction conflicts thus far encountered; and deadlock detection via the timestamp range mechanism, so that wait-for graph cycle detection is not needed.

A. Timestamps and Locking

1. Timestamps for Concurrency Control

Each of multiple versions of a data object (212, 214, or 216) supported by the multi-version database environment (200) can be stamped by the transaction (250, 252, or 254) that created the version. This “stamp” can be the transaction identifier for the creating transaction (250, 252, or 254), or it can be a timestamp for the time at which the creating transaction (250, 252, or 254) “committed”. If the “stamp” is an identifier, the “stamp” can be converted into a “timestamp” ordered consistent with the serialization order of the transactions. These version timestamps can facilitate choosing the appropriate version for each transaction (250, 252, or 254) to access.

2. Conflict Detection and Timestamps

The conflict manager (240) can choose timestamps for transactions (250, 252, and 254) that can be used with the versions of data objects (212, 214, and/or 216) created by each transaction (250, 252, and 254) to provide transaction time functionality. Accordingly, as noted above, the conflict manager (240) can choose the timestamps so they are ordered consistently with the serialization order of the transactions (250, 252, 254).

A conventional lock manager blocks a new access to a data object when the new access conflicts with an existing access from another transaction. Such a conventional lock manager has typically been used to support access to current data, even when transaction time versions are supported. The conflict manager (240) can be similar in many respects to a conventional lock manager, and the conflict management data structure (242) can be similar to conventional lock manager data structures because conflict detection can be the same. The non-conflict case, which is the most common, can remain unchanged from a conventional lock manager. Non-conflict access requests can take a fast path in and out of the conflict manager (240), as with conventional lock managers. However, the conflict manager (240) handles conflicts differently, by inspecting and sometimes adjusting timestamp ranges. A reward for this inspection and adjusting is that many read/write conflicts can proceed concurrently.

The conflict manager (240) can maintain a range of acceptable timestamps for each transaction. This timestamp range may be impacted by each conflicting access of the transaction with some other transaction. By having the conflict manager (240) adjust the acceptable timestamp ranges, each transaction timestamp range can be consistent with the conflicts that the transaction has encountered. Because the conflict manager (240) maintains ranges of timestamps for the transactions (250, 252, and 254), the conflict manager (240) can more flexibly re-order transactions, as compared with timestamp order methods that do not use ranges. This re-ordering can reduce the abort rate of the transactions (250, 252, and 254), while preserving the ability to choose an appropriate timestamp to maintain serializability of timestamp order.

Conventional lock managers maintain a conceptual matrix of transactions and data objects. When a transaction locks a data object, an entry is made tagging the appropriate matrix entry with this lock, linking the data object and the transaction via the lock. The matrix is usually accessed via hashing. A hash table references a collection of data objects, dividing them into “hash buckets”. At each data object, active accesses to the data object are enqueued. The conflict manager (240) can also keep access history available for a short time after transactions commit. Each transaction (250, 252, 254) may likewise be accessible via a hash table in the conflict management data structure (242) that refers to a set of transactions, each with a transaction control block (TCB). A TCB points to the set of data objects accessed by the transaction (250, 252, or 254) so that when the history for the transaction (250, 252, or 254) will no longer be useful to the conflict manager (240), it can be straightforward to remove the transaction's conflict manager entries.

The conflict manager (240) can maintain information not just about active transactions but also about recently committed transactions (that are still “alive” in that they can affect the serialization of active transactions). An active transaction might commit with a timestamp earlier than an already committed transaction. The conflict manager (240) can detect such cases, and adjust timestamp ranges appropriately as these extended conflicts are detected.

3. Blocking Instead of Aborting

In conventional snapshot isolation techniques, when two snapshot isolation transactions conflict on writes, one is aborted. When one has already committed, the currently active transaction is aborted. When both transactions are still uncommitted, either can be chosen to be aborted. Many implementations abort as soon as a write-write conflict is detected (eager abort). The conflict manager (240) can sometimes have a new writer be blocked and wait for another writer of a data object, as is done in conventional locking. The conflict manager (240) can also deal with some read-write conflicts that would otherwise result in aborts by having the requestor (the transaction making the request) wait. The conflict manager (240) can block requestors when concurrent access cannot be allowed and still maintain the serializable order of transaction timestamps, so that the other alternative, i.e., to abort, can be avoided. However, the conflict manager (240) can opt for increased concurrency when timestamp ranges permit it.

Blocking can lead to circular waiting or deadlock. Deadlocks are typically very low frequency but they can be dealt with to avoid some data objects be tied up indefinitely and some transactions prevented from completing. The conflict manager (240) can identify deadlocks using the same timestamp range validation as described herein, without having to trace conflict edges in a graph looking for circular waiting.

The conflict manager (240) can ensure that the timestamp range associated with each transaction (250, 252, and 254) has been adjusted so that it reflects all the conflicts it has encountered so far. Then when circular waiting arises, that circular waiting can be identified by the new conflict not being resolvable via adjustments to the timestamp ranges. The conflict manager (240) can be conservative in this manner, aborting in some cases where it might have been avoided. However, the typical low frequency of deadlock and even of multiple enqueued blocked transactions can alleviate the cost of this issue in terms of performance.

4. Transaction Attributes

As noted above, each transaction can be represented in the conflict management data structure (242) with a TCB, which can be linked in the conflict manager (240) to data objects (212, 214, and/or 216) being accessed by the transaction. Each transaction can have at least the following attributes:
TID: Transaction identifier X
X.early: earliest time at which X can commit. This can be initially set to the time the transaction begins.
X.end: (true) X.late is not null; (false) X.late is null. X.end can be initially false.
X.late: latest time at which X can commit.
X.committed: (true) X.timestamp is not null; (false) X.timestamp is null.
X.timestamp: time at which X is committed. (Note: One can use X.early or X.late to store X.timestamp instead of a separate field. It is kept separate here to make the exposition simpler.)
Isolation level: Conflicts and response to them may depend on transaction isolation level.
   In a transaction time database, X.timestamp can become the timestamp of all versions updated by transaction X when transaction X commits. Another transaction Y, reading at Y.early can see a serializable transaction consistent view of the database by reading a version with the largest timestamp less than or equal to Y.early.

Timestamps may not be physically stored in data object versions. The timestamp in the TCB can be sufficient so long as there is a mapping from a TID in the version to the TCB that is persistent. However, for transaction time functionality, driving the timestamps into the versions, as done in Immortal DB transaction time support for SQL Server® database server, can be desirable to avoid runtime translation overhead.

### IV. Case Analysis

The following sections will describe several conflict cases and describe how timestamp ranges may be adjusted in those cases. This section describes how the transactions involved will be described in those sections. For convenience, this is done in terms of the current requestor transaction (Q) for a lock and the current holder transaction (H) of a possibly conflicting lock for the same data object. Using Q and H as above, timestamp ranges are provided for each of Q and H so as to enumerate the cases. The cases are numbered in Table 1, and this numbering is used when analyzing each case under varying conflicts. In this implementation Q and H can have fields as described in the data structure above, initialized as described. The cases are broken down into sub-cases and then use, e.g. “case 1[2]” to indicate the second sub-case of major case 1. The next two sections describe how the conflict manager (240) can respond to conflicts. The next section treats read/write conflicts, showing how they can frequently be made concurrent. The following section (after the next section) describes how blocking, as done by a conventional lock manager, can be used instead of abort to handle many write/write conflicts and some read/write conflict cases that may have otherwise been aborted.

### V. Concurrent Read/Write Access

There are a large number of read/write conflict cases that can arise because the reader may be the requestor or holder, and the writer may be the requestor or holder. These are enumerated for each of the entries in Table 1 below. Table 2 below illustrates pictorially the conflict impact on timestamp ranges of the transactions only for the very first case, to illustrate pictorially how the adjustment can work. Adjustments for the first case and the other cases are described after Table 2. Note that in the cases below, when the discussion states that an early value for one range is set to the same value as a late value for another range, the values can be set so that they are off by at least one clock unit (such as the smallest unit possible, given the granularity of the clock) so that the ranges do not overlap. For example, all the ranges may be considered to be closed intervals on the early end, and open intervals on the late end. Note also that in the discussion below, the possible adjustments are described in terms of a particular implementation, and differences may be present in other implementations.

TABLE 1
Enumeration of Read-Write Conflict Cases
Time gets later from left to right in cases below.

| Case 1: Not Q.end, Not H.end | |
|---|---|
| 1. | Q.early>H.early |

|--H--------------------------------------------

|--Q-----------------------------------

| | |
|---|---|
| 2. | Q.early < H. early |

|--H------------------------------------

|--Q---------------------------------------------

| Case 2: Not Q.end, H.end | |
|---|---|
| 1. | Q.early > H.late |

|--H--|

|--Q----------------------------------

| | |
|---|---|
| 2. | Q.early > H.early & Q.early < H.late |

|--H--------|

|--Q-------------------------------------

| | |
|---|---|
| 3. | Q.early < H. early |

|--H--|

|--Q---------------------------------------------

| Case 3: Q.end, Not H.end | |
|---|---|
| 1. | Q.early > H. early |

|--H------------------------------------

|--Q--|

| | |
|---|---|
| 2. | Q.early < H.early & Q.late > H.early |

|--H----------------------------------------------

|--Q--------|

| | |
|---|---|
| 3. | Q.late < H.early |

|--H-----------------------------

|--Q--|

| Case 4: Q.end, H.end | |
|---|---|
| 1. | Q.early > H.late |

|--H--|

|--Q--|

| | |
|---|---|
| 2. | Q.early > H.early & Q.early < H.late & Q.late > |
| | H.late |

|--H--------|

|--Q------|

| | |
|---|---|
| 3. | Q.early > H.early & Q.late < H.late |

|--H---------------|

|--Q--|

| | |
|---|---|
| 4. | Q.early < H.early & Q.late > H.late |

|--H--|

|--Q------------------|

| | |
|---|---|
| 5. | Q.early< H.early & Q.late > H.early & Q.late < |
| | H.late |

|--H-----|

|--Q--------|

| | |
|---|---|
| 6. | Q.late < H.early |

|--H--------|

|--Q--|

Cases [2,4] are H.late in [Q.early, Q.late].
Cases [3,5] are Q.late in [H.early, H.late]

TABLE 2
Example Conflict Impact on Timestamp Range For Case 1
H is reader; Q is writer
Case 1 Result: Not Q.end, Not H.end;

| | |
|---|---|
| 1) | Q.early>H.early; |
| | a)Before: |
| | \|--H------------------------------------------- |

|--Q---------------------------------

b)After:

|--H----------------------------------------|

| | | |
|---|---|---|
| | | \|Q-- |
| 2) | Q.early < H. early | |
| | a)Before: | |

|--H---------------------------------

|--Q------------------------------------------

b)After:

|--H------------------------------|

|Q--

A. Case 1: Not Q.end; not H.end:

For this case, neither Q nor H has had prior conflicts that would result in a late bound and neither is committed. This is the most flexible read-write conflict situation. Concurrent read/write access can be done and abort is not needed. Table 2 illustrates for this case only how the timestamp ranges can be adjusted, with H as reader and Q as writer. In both sub-cases, the reader timestamp range can be “maximized” at the expense of the writer. The writer can be “pushed later”, i.e., to the current time. Following is a description of adjustments for the sub-cases in this case:
Q is writer, H is reader: Since neither Q nor H are constrained, the H (reader) acceptable time interval can be maximized. Thus (H.late, Q.early)←T_{write} where T_{write} is the current time.
Q is reader, H is writer: Since neither Q nor H are constrained, the Q (reader) acceptable time interval can be maximized. Thus (H.early, Q.late)←T_{read} where T_{read} is the current time.

B. Case 2: Not Q.end; H.end:

For this case H (the current holder of the data object) has a late bound. Most of the time, the conflict manager (240) can permit concurrent access for this case. There are a number of sub-cases to consider. Following is a description of adjustments for the sub-cases in this case:
Q is writer, H is reader: Concurrent read/write access can be done without aborting because the writer can be pushed back. Again, the reader is given as much of the time intervals in question as can be done without requiring the writer to abort. Q.early=max(H.late, Q.early).
Q is reader, H is writer: Concurrent access can frequently be done, but abort is sometimes done.
   [1] Q.early>H.late: In this case, the reader cannot be put ahead of the writer. Thus, concurrent access (where the reader reads an earlier version) is not done. The writer H may be aborted if H is uncommitted, but see the discussion below on blocking. With H committed, H's version is the version that Q will see and read.
   [2,3] Q.early<H.late: Q.early is set to be as late as possible without aborting the writer H. Thus, (Q.late, H.early)←H.late. Concurrent read-write access can be done in this sub-case.

C. Case 3: Q.end; Not H.end:

For this case Q (the requesting transaction of the data object) has a late bound. Concurrent access can be permitted most of the time for this case. However, there are a number of sub-cases to consider:
Q is writer, H is reader: Concurrent access is frequently possible.
   [1,2] Q.late>H.early: In this case, the reader H can be put ahead of the writer Q. The maximum interval can be given to the reader, as follows: (H.late, Q.early)←Q.late.
   [3] Q.late<H.early: The reader cannot be put ahead of the writer, so the writer Q, who is uncommitted, may be aborted. But see the discussion below on blocking.
Q is reader, H is writer: Concurrent access can be done, without aborting. Again, the conflict manager (240) can maximize the time interval given to the reader, without requiring the writer to abort. Here, H (writer early time) can be pushed back as much as possible so as not to shrink the reader time interval, as follows: H.early←max(Q.late, H.early).

D. Case 4: Q.end; H.end:

This case has the most (6) sub-cases. However sub-cases can be merged. In many cases concurrent access can be permitted by ordering the reader before the writer, only aborting sometimes when this cannot be done.
Q is writer, H is reader: Many of the sub-cases below can permit concurrent access, though an abort may be done in cases where the reader cannot be pushed ahead of the writer.
   [1] Q.early>H.late: The ordering is fine for concurrent access without changing the ranges for either reader or writer.
   [2,4] H.late in [Q.early, Q.late]: Set Q.early←H.late. This preserves the reader H's time range, while shrinking the writer's range.
   [3,5] Q.late in [H.early, H.late]: (H.late, Q.early)←Q.late if H is not committed. This shortens the reader's range, but by the smallest amount while avoiding abort. If H is committed, then H.early=H.late and this case does not exist.
   [6] Q.late<H.early: The reader H cannot be put before the writer, the writer Q can be aborted. This abort that is not avoided by blocking.
Q is reader, H is writer: Similar to the role reversed case above, many sub-cases can permit concurrent access, though sometimes abort is done.
   [1] Q.early>H.late: The reader cannot be pushed ahead of writer, the writer H may be aborted if H is uncommitted, but see the discussion of blocking below. If H is committed, Q will read the version produced by H.
   [2,4] H.late in [Q.early, Q.late]: (Q.late, H.early)←H.late. This maximizes the reader time range without forcing the writer to abort.
   [3,5] Q.late in [H.early, H.late]: H.early←Q.late. This leaves the reader time range unchanged, while avoiding abort for the writer.
   [6] Q.late<H.early: The reader is already ahead of the writer, so concurrent access can be permitted without changing the time ranges.

### VI. Blocking Instead of Abort

A. Blocking Overview

In “traditional” snapshot isolation, when there is a write-write conflict, one of the transactions involved is aborted. However, with the conflict manager (240), that may not be the only choice. The conventional locking technique of blocking one transaction until the other commits may be used. Following is a discussion of the cases where abort may have otherwise been done. The conflict manager (240) can ensure that timestamp ranges reflect all the conflicts that a transaction (250, 252, or 254) has encountered, including when blocked, so that a timestamp range test can cope with deadlock, aborting one of the blocked transactions.

B. Read-Write Abort Cases

The preceding discussion of the read-write conflict cases identified a number of cases in which reads could not safely be permitted to proceed concurrently with a write (via the reader accessing an earlier version). Those cases will be revisited here with a discussion of how blocking, as done for conventional locking, can handle some of those cases without aborting one of the transactions. Following is a discussion of these cases:
Case 2[1]: Q.early>H.late: Q a reader, H a writer. The reader cannot be placed earlier than the writer. However, the reader Q can be blocked until the writer H commits, and then Q can read H's committed version, turning the uncommitted writer case into the committed writer case. No changes are needed to timestamp ranges for this to be effective, as H already has a bounded range.
Case 3[3]: Q.late <H.early: Q a writer, H a reader. Again, the reader cannot be placed ahead of the writer. However, this is a case where the reader has already read an earlier version. So this cannot be solved by blocking. One of the transactions is aborted, and the policy may be to abort the writer Q when that is possible.
Case 4[6] Q.late<H.early: Q a writer, H a reader Like case 3[3], the reader cannot be placed ahead of the writer, and blocking Q does not solve the problem because Q is constrained to have a timestamp earlier than H. Thus one of the transactions is aborted, and the policy may be to abort the writer Q.
Case 4[1] Q.early>H.late: Q a reader, H a writer. The writer is constrained to be earlier than the reader. However, in this case, the reader Q can wait for the writer H to commit. Accordingly, Q can be blocked until H commits.

Thus, out of four cases where previous strategies would have aborted, acceptable transaction ordering can be achieved, as reflected in timestamps, by blocking in two of the cases (case 2[1] and case 4[1]), the two cases where Q is a reader. Blocking is usually a more desirable result than aborting.

C. 4.3 Write-Write Conflicts

As with read-write conflicts, some write-write conflicts can be resolved by blocking Q and waiting for H to commit. In the following, both the holder H and the requestor Q are writers. Cases are given below. Previous multi-version concurrency control approaches based on snapshot isolation aborted one of the transactions in such cases. Following is a discussion of the cases:
Case 1: Not Q.end, Not H.end: Set H.end. (Q.early, H.late)←T_write (time of write or current system time). Q blocks waiting for H to end.
Case 2: Not Q.end; H.end: Q blocks waiting for H to end. If H is already committed, then access is immediate for Q.
   [1] Q.early>H.late then no change.
   [2,3] Q.early<H.late then Q.early←H.late.
Case 3: Q.end, not H.end: Q blocks waiting for H to end. Or abort.
   [1,2] Q.late>H.early then (H.late, Q.early)=Q.late. Q waits for H to commit.
   [3] Q.late<H.early then abort Q or H. Q is constrained to be earlier than H, but H has already read and written its version of the data object.
Case 4: Q.end, H.end: Q blocks waiting for H to end. Or abort Q or H.
   [1] Q.early>H.late then no change. Q blocks waiting for H to end.
   [2,4] H.late in [Q.early, Q.late]: Q.early←H.late. Q blocks waiting for H to end.
   [3, 5] Q.late in [H.early, H.late] then (Q.early, H.late)←Q.late. Q blocks waiting for H to end.
   [6] Q.late<H.early then abort Q or H. Q waiting for H to commit does not help because Q precedes H.

### VII. System Operation

Following is a discussion of how the operation of the conflict manager (240) can fit into a wider system. Three aspects will be discussed:
What is done in the conflict manager (240) when conflicts are detected? Detecting conflicts and the no-conflict case handling can remain unchanged from the traditional lock manager.
How are significant milestones in a transaction's execution impacted?
How is the locking information of committed transactions garbage collected? This can be done at a time later than transaction commit time.

A. Conflict Manager Conflict Handling

For any database object, a requesting transaction may conflict with more than one transaction that has “locked” it. For example, a writer conflicts with every reader of a data object. Further, when transactions block waiting for a data object, the requesting transaction can conflict with multiple blocked transactions enqueued on the data object. A discussion of these cases follows.

1. Data Object with at Least One reader and No Writers

A writer, if it is to proceed concurrently with existing readers of a data object, will come after the existing readers. Thus the writer start time is later than the end times of the readers. Hence, A.early for writing transaction A is the latest time for the readers.

While a writer might be able to execute concurrently with some readers, for the writer to proceed, it will have to execute concurrently with all the readers. If not, this is because the writer timestamp range forces it to precede at least one of the readers. In this case, the writer may be aborted because the “problem” reader has already read a version that is different from the one that would be created by the writer.

2. Data Object with at Least One Writer

When a transaction has written a data object, and has an X “lock” on it, readers can be permitted to execute concurrently by reading an earlier version, when that can be done. If a new reader does not have a timestamp range that permits it to read the earlier version, that reader can be blocked. Both in the concurrent case and the blocked case, the analysis discussed above can be used to determine each reader's timestamp range. A read requester does not need to abort; it can proceed either concurrently with the writer by reading an earlier version, or by waiting for the writer to commit and then reading this new version.

A reader can be pushed forward in the queue of writers waiting on the “locked” data object as far as possible, until it reaches a writer that has to precede it. If there is no such writer, the read can execute concurrently with the active writer. A new reader's timestamp range is impacted by the writers of the data object, not by the concurrent (or blocked and waiting readers). A read requestor can proceed without being delayed by blocked readers.

If a writer accesses a data object with an existing writer, it can either abort or block waiting for the data object. The new writer can block if it has a timestamp range that permits it to follow the writer and all the concurrent readers and/or blocked readers and writers as well. Otherwise the new writer can be aborted.

B. Transaction Stages

This section discusses the state of a transaction's variables at the beginning and end of a transaction as follows:

BeginTransaction(A): Execute existing begin code, then do the following:
Set A.early=current time; A.end=false; A.commit=false; both A.late and A.timestamp are indicated as being undefined because A.end and A.commit are “false”.

EndTransaction(A, commit/abort)

For commit, execute existing code for commit, then do the following:
Set A.commit=1; A.timestamp←A.early; A.late←A.early. The earliest time can be chosen for the commit time. Reasons for this choice are discussed below, although other choices are possible. A's locks are not removed from the conflict manager (240) at this time.

For abort, execute existing code for abort, then do the following:
Remove transaction A locks from the conflict manager (240).

At transaction end, transactions waiting on A's locks can be unblocked, permitting those transactions to resume execution.

C. Multi-Granularity Locking

The conflict manager (240) can identify conflicts involving multi-granularity locks the same way that this is currently done in a conventional lock manager. The lock mode conflict matrix can be unchanged. Further, as noted previously, the non-conflict case can be unchanged in going from a conventional lock manager and the conflict manager (240).

To deal with conflicts, lock modes can be associated with reader and writer access so that the case analysis discussed above can be used to determine whether concurrent access, blocking, or abort is to result. The following simple rule can be used: if a lock mode conflicts with an S lock, then the transaction requesting a lock in that mode can be treated as a writer, and can have timestamp ranges adjusted accordingly in conflicts. All locks not conflicting with an S lock can be treated as readers when they conflict with other operations (from writers).

Using this and the traditional multi-granularity hierarchy, S and IS lock modes can be considered readers, and IX, SIX, and X lock modes can be considered writers. How to treat these lock modes in the analysis of conflicts can flow directly from this classification. This approach is conservative. For example, someone holding an IX lock on a table will conflict with a transaction with an S lock on the table, even though the IX locker might never actually write. This is similar to the conventional lock manager case where one of the transactions involved will block (perhaps unnecessarily).

Two IX locks may not conflict, even though they can both be treated as writers if there is a conflict. This can be workable because treating the lock mode as writers only applies to conflict cases. There is no conflict at this point. If a conflict arises, it will be when both transactions attempt to X lock the same lower level data object, e.g., a data record.

D. Deadlock Detection

Recall that all ordering requirements resulting from conflicts can be reflected in the timestamp range of a transaction, including transactions blocked waiting for a data object. Thus, a blocked transaction has a timestamp range that is disjoint from conflicting transactions earlier in the queue and is later than the timestamp ranges for those transactions.

When there is circular waiting, a transaction A that completes that cycle (resulting in a deadlock) has blocked other transactions B, C, etc. and is now being blocked by one of these transactions or by another transaction blocked by these. All these transactions will have timestamp ranges disjoint with A and later than A. The requirement, when A is blocked, is that it be later than the transaction blocking it. But this cannot be done while maintaining serializability. Hence the deadlock is “detected” because the conflict manager (240) cannot find a timestamp range that works for A, and A (or the blocking transaction) can be aborted.

E. Conflict Manager Garbage Collection

Before removing a transaction A's locks from the conflict manager (240), the garbage collection can wait until A's commit timestamp can no longer impact the timestamp ranges of active write transactions. By choosing the earliest timestamp in the acceptable range, the time when A can be removed may be hastened. A's having read a version of a datum D forces writers of D to be later than A. Thus, once no B exists with B.early A.timestamp, A can be removed. Garbage collection for read only transactions is discussed below.

A's “locks” can be removed at a later time, but not earlier. Thus, B.early can be tracked for active writers B, but this can be done in a conservative way. One approach, though there are others, is to count the number of active transactions B with B.early in a small interval Δt. When the count in an interval Δt goes to 0, the earliest non-zero interval ΔT can be found, committed transactions in the conflict manager (240) with timestamps earlier than the start of ΔT can be deleted.

### VIII. Discussion

A. Other Conflict Policies

The description above has utilized certain policies and rules. However, those policies and rules are not to be construed as limitations on the claims below or on the overall tools and techniques described herein. For example, the description above has used a conflict policy of favoring the reader. However, other policies may be used, and a final choice for a policy could be based on an analysis of system throughput and abort rates.

A few alternative timestamp range policies in addition to always favoring the reader are: 1) make the impact on reader and writer be equal; 2) favor the writer at the expense of the reader; 3) favor the current holder of the data object at the expense of the requestor; 4) favor the transaction with the earliest start time at the expense of a later transaction. As with timestamp ranges, there are alternative abort victim policies. The discussion above chose the writer as the abort victim. Some other possible choices for the abort victim are: 1) the reader; 2) the requestor; 3) the holder; 4) the later transaction, based on start time; 5) the transaction with the fewest conflicts.

B. Optimizing Read-Only Transactions

When a transaction RO declares itself to be read-only, which is supported in at least some commercial systems, RO need not set any “locks”. Such a declaration can be taken to mean that RO does not need to ask the conflict manager (240) for permission to access data objects (212, 214, and/or 216) if RO identifies a recent time at which there are no concurrent transactions, i.e. earlier than the A.early of any active read/write transaction. RO can run an “as of” query for this time, just like a typical historical “as of” query.

If RO is active concurrently with active writers, then it can participate in keeping the overall schedule serializable, without aborting RO. RO.early can be set equal to RO.late to minimize its conflicts with concurrent read/write transactions. Further, once RO's time is earlier than A.early for any active read-write transaction, RO can continue its execution without conflict manager (240) visits, like an “as of” historical query.

C. Isolation Levels

SQL isolation levels are tied to how locks are taken or not taken during a transaction. A repeatable read transaction, which does not guarantee serializability, does not set range locks. A dirty read transaction (allowed in the read uncommitted isolation level) does not set S locks when it reads, and hence does not see a conflict with a write lock. Locks not taken may not impact transaction ordering, i.e. they are no-conflict cases so they may not impact transaction timestamp ranges. These isolation levels, and their relaxed concurrency follows from the reduction in locking and hence in the number of conflicting accesses.

A read committed transaction only sets short term read (S) locks, and hence is less likely to see a conflict with a writer. Any writer and its locks thus avoided may not impact timestamp range or the ordering of transactions. This can increase the chance that the read committed transaction will successfully commit.

For data objects being read that already have an uncommitted writer, the definition of read committed is not crisp. There are two possible versions that might be read: (1) the latest already committed version, or (2) wait until an X lock holder commits, and then read its newer version. One approach can usually read the earlier version, but in a few cases, can wait for the writer to commit and then read the new version. In each case, the timestamp ranges of the transactions involved can be adjusted. This may result in some adjustments that could have been avoided. But this may be sufficient because, as noted, the definition is not crisp.

The conflict manager (240) can already allow frequent concurrent access, so the need to use snapshot isolation is greatly reduced. To improve performance using snapshot isolation, the timestamp range adjustments for read-write conflicts may be turned off, so isolation level could be checked in the TCB when deciding how to proceed with respect to snapshot isolation.

D. Update Locks

Update (U) mode locks are frequently taken on a data object when the data object is read to decide whether it is to be modified or not. Two U mode locks can conflict, and can prevent a potential deadlock that would arise if two transactions had S mode locks on a data object, and both wanted to write (modify) it. Instead, a transaction that might write a data object has to have a U lock on the data object before it can upgrade the lock to an X lock. S lockers cannot upgrade to a U mode lock. They would take the U mode lock on a previously unlocked data object. U mode locks do not conflict with S mode locks, which can be a benefit for reducing conflicts.

With the policy above, a U locker may be classified as a reader because U does not conflict with S. The X mode required before a data object can be written would capture the reader-writer distinction when it occurs. However, this does not tell us how to handle U-U conflicts, present to protect against possible deadlock. Classifying U as reader leads to undesirable behavior in the case of U-X conflicts also, because there is generally no blocking on read-write conflicts, but instead allow a reader read an earlier version. But if that happens, the U locker will be aborted if it tries to upgrade to an X lock because no timestamp range will work.

Following is a possible solution to this scenario, although others may be used. When readers conflict, as they do in the U-U case (but not in the S-S or U-S cases), then the requestor can be blocked. This blocking forces the U requestor Q to have a timestamp range later than the U holder H. If H upgrades to an X lock, the read/write conflict does not result in concurrent access because the U requestor now has a timestamp range after the range of H. Accordingly, this situation can be resolved without aborting by having U (a reader) wait for X (a writer).

E. Transaction Time Database Systems

Transaction time database systems provide multi-version support, including support for queries “as of” some past time in order to read a transaction consistent version of the database at a prior time. Immortal DB is one example that went to great effort to reduce the penalty of supporting versions on current database access performance, reducing it to only a few percent. Adding timestamp range lock management to a transaction time database can turn things around. With more concurrency for multiple versions, current database access can be improved. Supporting multiple versions may thus turn into a performance plus, not a penalty to be minimized.

Adding a conflict manager (240) as described above to a transaction time database can have a limited implementation impact. It may be implemented without changing versioning or “as of” query functionality. The conflict manager (240) may be implemented so that it impacts the way in which timestamps are selected, without changing the timestamping process itself.

The detailed discussion above has described possible implementations of the tools and techniques described herein, but those implementations are not to be taken as limitations on the claims below or on the general tools and techniques described herein.

IX. Techniques for Multi-Version Concurrency with Ordered Timestamps

Several techniques for multi-version concurrency with ordered timestamps will now be discussed. Each of these techniques can be performed in a computing environment. For example, each technique may be performed in a computer system that includes at least one processor and a memory including instructions stored thereon that when executed by the at least one processor cause the at least one processor to perform the technique (a memory stores instructions (e.g., object code), and when the processor(s) execute(s) those instructions, the processor(s) perform(s) the technique). Similarly, one or more computer-readable storage media may have computer-executable instructions embodied thereon that, when executed by at least one processor, cause the at least one processor to perform the technique.

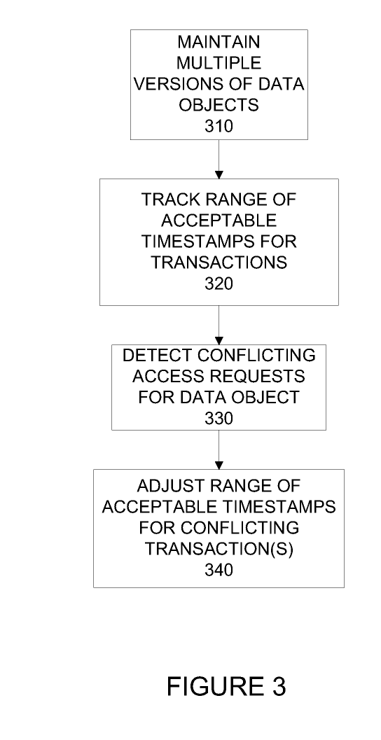

Referring to FIG. 3, a technique for multi-version concurrency with ordered timestamps will be discussed. The technique can include maintaining (310) multiple versions of a set of data objects to allow concurrent conflicting access to the data objects. The technique can also include tracking (320) a range of acceptable timestamps for each database transaction in a set of database transactions. Conflicting access requests for a data object in the set of data objects can be detected (330). The conflicting access requests could be made by two or more conflicting database transactions in the set of database transactions. For example, detecting conflicting access requests can include detecting requests for conflicting locks on the data object for overlapping time periods. The technique can further include adjusting (340) a range of acceptable timestamps for at least one of the conflicting transactions, such that an order of transaction timestamps for the set of database transactions can be maintained in accordance with a specified isolation level, such as a serializable isolation level.

The conflicting transactions may include a first transaction requesting access to read the object and a second transaction requesting access to write to the object. If so, a range of acceptable timestamps for the second transaction can be adjusted. Additionally, the technique can further include determining whether the first and second transactions can be allowed to concurrently access the data object while maintaining the order of transaction timestamps for the set of database transactions in accordance with the specified isolation level. If the first and second transactions can be allowed to concurrently access the data object while maintaining an order of transaction timestamps for the set of database transactions in accordance with the specified isolation level, then the first and second transactions can be allowed to concurrently access the data object. Allowing the first and second transactions to concurrently access the data object can include allowing the first transaction to access a version of the object that is earlier than a version of the object produced by the second transaction.

The conflicting transactions may include first and second transactions that are both requesting access to write to the object. If so, the technique can further include determining whether the first transaction can be blocked from accessing the object while the second transaction accesses the object, without aborting either the first or second transaction, while maintaining an order of transaction timestamps for the set of database transactions in accordance with the specified isolation level. If so, then the technique can further include blocking the first transaction while the second transaction accesses the object.

The technique can further include assigning each database transaction in the set of database transactions a timestamp in the range of acceptable timestamps between an actual clock start time and an actual clock commit time for that transaction. This may include assigning each database transaction in the set of database transactions an earliest timestamp in a range of acceptable timestamps for that transaction. Additionally this assigning can be done so that the assigned timestamps are in an order of transaction timestamps for the set of database transactions that is in accordance with the specified isolation level.

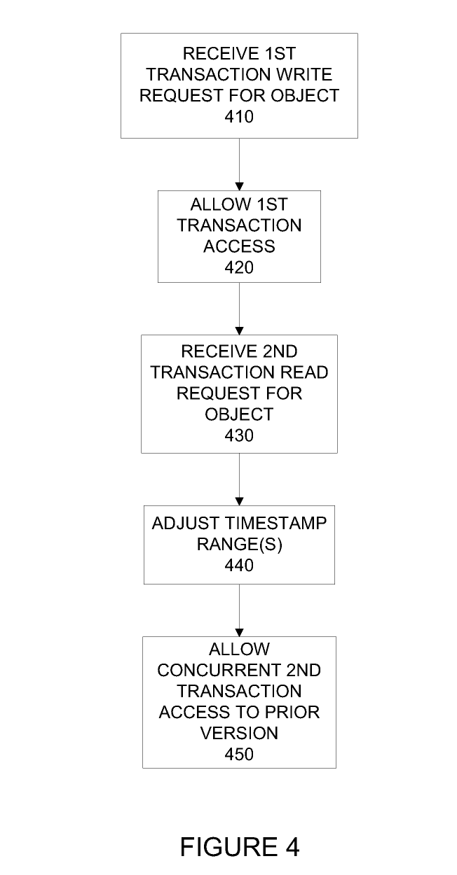

Referring to FIG. 4, another technique for multi-version concurrency with ordered timestamps will be discussed. The technique can include receiving (410) a request for a first transaction to access a data object in the set of data objects to perform a write operation on the data object to produce a modified version of the object. The first transaction can be allowed (420) to access the data object to perform the write operation. Additionally, a request for a second transaction to access the data object to perform a read operation on the data object can be received (430). A range of acceptable timestamps for at least one of the first and second transactions can be adjusted (440). This can be done such that an acceptable timestamp range for the first transaction and an acceptable timestamp range for the second transaction are in an order of transaction timestamps that is in accordance with a specified isolation level. Additionally, the second transaction can be allowed (450) to access an earlier version of the data object to perform the read operation, where the earlier version is prior to the modified version. The allowing (420) of the first transaction and the allowing (450) of the second transaction can be concurrent.

The technique of FIG. 4 can further include managing a set of database transactions on a set of data objects, where the database transactions include the first and second transactions, and the set of data objects include the data object for which access is requested. Multiple versions of at least some of the data objects can be managed. Additionally, adjusting the range of acceptable timestamps can be done such that the acceptable timestamp range for the first transaction and the acceptable timestamp range for the second transaction are in an order of transaction timestamps for the set of database transactions that is in accordance with the specified isolation level.

Where the data object is a first data object, the technique can further include receiving a request for a third transaction to access a second data object in the set of data objects to perform a write operation on the second data object, as well as receiving a request for a fourth transaction to access the second data object in the set of data objects to perform a write operation on the second data object. The third transaction can be allowed to access the second data object, and the fourth transaction can be blocked from accessing the second data object until after the third transaction finishes accessing the second data object. A range of acceptable timestamps for at least one of the third and fourth transactions can be adjusted, such that an acceptable timestamp range for the third transaction and an acceptable timestamp range for the fourth transaction are in an order of transaction timestamps that is in accordance with the specified isolation level.

The technique of FIG. 4 can further include assigning the first transaction a timestamp from an acceptable timestamp range between the first transaction's actual clock start time and actual clock commit time for the first transaction and assigning the second transaction a timestamp from an acceptable timestamp range between the second transaction's actual clock start time and actual clock commit time for the second transaction.

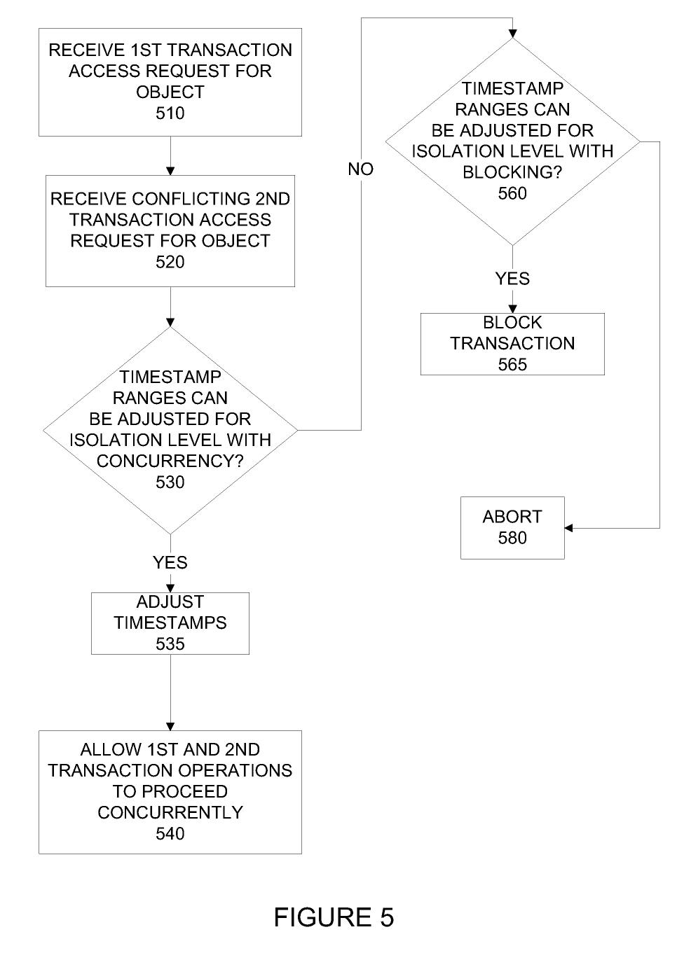

Referring to FIG. 5, yet another technique for multi-version concurrency with ordered timestamps will be discussed. The technique can include receiving (510) a request for a first transaction to access a data object to perform a first operation on the data object, and receiving (520) a request for a second transaction to access the data object to perform a second operation on the data object. The first operation can present a conflict with the second operation. It can be determined (530) whether one or both of the acceptable timestamp ranges for the first and second transactions can be adjusted to allow the first and second operations to proceed concurrently while maintaining an order of transaction timestamps in accordance with a specified isolation level. If so, then one or both of the acceptable timestamp ranges for the first and second transactions can be adjusted (535) to maintain an order of transaction timestamps in accordance with the specified isolation level, and the first and second operations can be allowed (540) to proceed concurrently.

Determining (530) may include determining whether the first and second operations are read operations or write operations, which can be in addition to other determinations, such as determining existing acceptable timestamp ranges for the first and second transactions. Determining whether the operations are read or write operations may include identifying a type of lock requested for the first operation and a type of lock requested for the second operation.

The technique may further include assigning the first transaction a timestamp from the acceptable timestamp range for the first transaction between the first transaction's actual clock start time and actual clock commit time, as well as assigning the second transaction a timestamp from the acceptable timestamp range for the second transaction between the second transaction's actual clock start time and actual clock commit time.

If it is determined (530) that one or both of the timestamp ranges for the first and second transactions cannot be adjusted to allow the first and second operations to proceed concurrently while maintaining an order of transaction timestamps in accordance with the specified isolation level, then the technique can further include determining (560) whether one or both of the timestamp ranges for the first and second transactions can be adjusted to allow the first and second operations to proceed while maintaining an order of transaction timestamps in accordance with the specified isolation level if one of the first and second operations is blocked while the other proceeds. If so, then one of the first and second operations can be blocked (565) while the other proceeds, and the technique may further include adjusting one or both of the timestamp ranges for the first and second transactions to maintain an order of transaction timestamps in accordance with the specified isolation level. If not, then at least one of the first and second transactions can be aborted (580).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/we claim:

1. One or more computer-readable storage media having computer-executable instructions embodied thereon that, when executed by at least one processor, cause the at least one processor to perform acts comprising:
maintaining multiple versions of a set of data objects to allow concurrent conflicting access to the data objects;
tracking a range of acceptable timestamps for each database transaction in a set of database transactions;
detecting conflicting access requests for a data object in the set of data objects, the conflicting access requests being made by two or more conflicting database transactions in the set of database transactions; and
adjusting a range of acceptable timestamps for at least one of the conflicting transactions, such that an order of transaction timestamps for the set of database transactions can be maintained in accordance with a specified transaction isolation level.

2. The one or more computer-readable storage media of claim 1, wherein the specified transaction isolation level is serializable.

3. The one or more computer-readable storage media of claim 1, wherein detecting conflicting access requests comprises detecting requests for conflicting locks on the data object for overlapping time periods.

4. The one or more computer-readable storage media of claim 1, wherein the conflicting transactions comprise a first transaction requesting access to read the data object and a second transaction requesting access to write to the data object, and wherein the acts further comprise:
determining whether the first and second transactions can be allowed to concurrently access the data object while maintaining an order of transaction timestamps for the set of database transactions in accordance with the specified transaction isolation level; and
if the first and second transactions can be allowed to concurrently access the data object while maintaining an order of transaction timestamps for the set of database transactions in accordance with the specified transaction isolation level, then allowing the first and second transactions to concurrently access the data object.

5. The one or more computer-readable storage media of claim 4, wherein adjusting a range of acceptable timestamps for at least one of the conflicting transactions comprises adjusting a range of acceptable timestamps for the second transaction.

6. The one or more computer-readable storage media of claim 4, wherein allowing the first and second transactions to concurrently access the data object comprises allowing the first transaction to access a version of the object that is earlier than a version of the object produced by the second transaction.

7. The one or more computer-readable storage media of claim 1, wherein the conflicting transactions comprise a first transaction requesting access to write to the object and a second transaction requesting access to write to the object, and wherein the acts further comprise:
determining whether the first transaction can be blocked from accessing the object while the second transaction accesses the object without aborting either the first or second transaction, while maintaining an order of transaction timestamps for the set of database transactions in accordance with the specified transaction isolation level; and
if the first transaction can be blocked from accessing the object while the second transaction accesses the object without aborting either the first or second transaction, while maintaining an order of transaction timestamps for the set of database transactions in accordance with the specified transaction isolation level, then blocking the first transaction while the second transaction accesses the object.

8. The one or more computer-readable storage media of claim 1, wherein the acts further comprise assigning each database transaction in the set of database transactions a timestamp in the range of acceptable timestamps between an actual clock start time and an actual clock commit time for that transaction.

9. The one or more computer-readable storage media of claim 8, wherein assigning each database transaction in the set of database transactions a timestamp comprises assigning each database transaction in the set of database transactions an earliest timestamp in a range of acceptable timestamps for that transaction.

10. The one or more computer-readable storage media of claim 1, wherein:
the specified transaction isolation level is serializable;
detecting conflicting access requests comprises detecting requests for conflicting locks on the data object for overlapping time periods;
the conflicting transactions comprise a first transaction and a second transaction;
if the first transaction is requesting access to read the object and the second transaction is requesting access to write to the object, then the acts further comprise:
determining whether the first and second transactions can be allowed to concurrently access the data object while maintaining an order of transaction timestamps for the set of database transactions in accordance with the specified transaction isolation level; and
if the first and second transactions can be allowed to concurrently access the data object while maintaining an order of transaction timestamps for the set of database transactions in accordance with the specified transaction isolation level, then allowing the first and second transactions to concurrently access the data object;
if the first transaction is requesting access to write to the object and a second transaction is requesting access to write to the object, and then the acts further comprise:
determining whether the first transaction can be blocked from accessing the object while the second transaction accesses the object without aborting either the first or second transaction, while maintaining an order of transaction timestamps for the set of database transactions in accordance with the specified transaction isolation level; and
if the first transaction can be blocked from accessing the object while the second transaction accesses the object without aborting either the first or second transaction, while maintaining an order of transaction timestamps for the set of database transactions in accordance with the specified transaction isolation level, then blocking the first transaction while the second transaction accesses the object; and
the acts further comprise assigning each database transaction in the set of database transactions a timestamp in the range of acceptable timestamps from an actual start clock time and an actual commit clock time for that transaction so that the assigned timestamps are in an order of transaction timestamps for the set of database transactions in accordance with the specified transaction isolation level.

11. A computer-implemented method, comprising:
receiving a request for a first transaction to access a data object in a set of data objects to perform a write operation on the data object to produce a modified version of the object;
receiving a request for a second transaction to access the data object to perform a read operation on the data object;
allowing the first transaction to access the data object to perform the write operation;
allowing the second transaction to access an earlier version of the data object to perform the read operation, the earlier version being prior to the modified version, and the allowing of the first transaction and the allowing of the second transaction being concurrent; and
adjusting a range of acceptable timestamps for at least one of the first and second transactions, such that an acceptable timestamp range for the first transaction and an acceptable timestamp range for the second transaction are in an order of transaction timestamps that is in accordance with a specified transaction isolation level.

12. The method of claim 11, further comprising:
managing a set of database transactions on a set of data objects, the database transactions comprising the first transaction and the second transaction, and the set of data objects comprising the data object; and
managing multiple versions of at least some of the data objects;
wherein adjusting the range of acceptable timestamps is done such that the acceptable timestamp range for the first transaction and the acceptable timestamp range for the second transaction are in an order of transaction timestamps for the set of database transactions that is in accordance with the specified transaction isolation level.

13. The method of claim 12, wherein the data object is a first data object and the method further comprises:
receiving a request for a third transaction to access a second data object in the set of data objects to perform a write operation on the second data object;
receiving a request for a fourth transaction to access the second data object in the set of data objects to perform a write operation on the second data object;
allowing the third transaction to access the second data object;
blocking the fourth transaction from accessing the second data object until after the third transaction finishes accessing the second data object;
allowing the fourth transaction to access the second data object after the third transaction finishes accessing the second data object; and
adjusting a range of acceptable timestamps for at least one of the third and fourth transactions, such that an acceptable timestamp range for the third transaction and an acceptable timestamp range for the fourth transaction are in an order of transaction timestamps that is in accordance with the specified transaction isolation level.

14. The method of claim 11, further comprising assigning the first transaction a timestamp from an acceptable timestamp range between the first transaction's actual clock start time and actual clock commit time and assigning the second transaction a timestamp from an acceptable timestamp range between the second transaction's actual clock start time and actual clock commit time.

15. A computer system comprising:
at least one processor; and
a memory comprising instructions stored thereon that when executed by the at least one processor cause the at least one processor to perform acts comprising:
receiving a request for a first transaction to access a data object to perform a first operation on the data object;
receiving a request for a second transaction to access the data object to perform a second operation on the data object, the first operation presenting a conflict with the second operation;
determining whether one or both of an acceptable timestamp range for the first and an acceptable timestamp range for the second transaction can be adjusted to allow the first and second operations to proceed concurrently while maintaining an order of transaction timestamps in accordance with a specified transaction isolation level;
if one or both of the acceptable timestamp ranges for the first and second transactions can be adjusted to allow the first and second operations to proceed concurrently while maintaining an order of transaction timestamps in accordance with the specified transaction isolation level, then allowing the first and second operations to proceed concurrently.

16. The computer system of claim 15, wherein determining whether one or both of the acceptable timestamp ranges for the first and second transactions can be adjusted to allow the first and second operations to proceed concurrently while maintaining an order of transaction timestamps in accordance with the specified transaction isolation level comprises determining whether the first and second operations are read operations or write operations.

17. The computer system of claim 15, wherein if the first and second operations are allowed to proceed concurrently, then the acts further comprise adjusting one or both of the acceptable timestamp ranges for the first and second transactions to maintain an order of transaction timestamps in accordance with the specified transaction isolation level.

18. The computer system of claim 17, wherein the acts further comprise:
assigning the first transaction a timestamp from the acceptable timestamp range for the first transaction between the first transaction's actual clock start time and actual clock commit time; and
assigning the second transaction a timestamp from the acceptable timestamp range for the second transaction between the second transaction's actual clock start time and actual clock commit time.

19. The computer system of claim 15, wherein if one or both of the timestamp ranges for the first and second transactions cannot be adjusted to allow the first and second operations to proceed concurrently while maintaining an order of transaction timestamps in accordance with the specified transaction isolation level, then the acts further comprise:
determining whether one or both of the timestamp ranges for the first and second transactions can be adjusted to allow the first and second operations to proceed while maintaining an order of transaction timestamps in accordance with the specified transaction isolation level if one of the first and second operations is blocked while the other proceeds;
if one or both of the timestamp ranges for the first and second transactions cannot be adjusted to allow the first and second operations to proceed while maintaining an order of transaction timestamps in accordance with the specified transaction isolation level, if one of the first and second operations is blocked while the other proceeds, then aborting at least one of the first and second transactions; and
if one or both of the timestamp ranges for the first and second transactions can be adjusted to allow the first and second operations to proceed while maintaining an order of transaction timestamps in accordance with the specified transaction isolation level, if one of the first and second operations is blocked while the other proceeds, then blocking one of the first and second operations while the other proceeds.

20. The computer system of claim 19, wherein if one or both of the timestamp ranges for the first and second transactions can be adjusted to allow the first and second operations to proceed while maintaining an order of transaction timestamps in accordance with the specified transaction isolation level, if one of the first and second operations is blocked while the other proceeds, then the acts further comprise adjusting one or both of the timestamp ranges for the first and second transactions to maintain an order of transaction timestamps in accordance with the specified transaction isolation level.
